(19) United States
(12) Patent Application Publication
(10) Pub. No.: US 2018/0209585 A1
(43) Pub. Date: Jul. 26, 2018

(54) Treadmill Lubrication System and Method

(71) Applicant: Robert McKenna, Spartanburg, SC (US)

(72) Inventor: Robert McKenna, Spartanburg, SC (US)

(21) Appl. No.: 15/414,175

(22) Filed: Jan. 24, 2017

(51) Int. Cl. F16N 3/08; A63B 22/02; B05B 11/00

(52) U.S. Cl. CPC F16N 3/08; B05B 11/3057; B05B 11/0089; A63B 22/02

(57) ABSTRACT

A treadmill lubrication system and method is provided. In a preferred embodiment, the lubrication system comprises a spray bottle with a nozzle including an extended tube through which a silicone-based lubricant may be sprayed. The extended tube of the nozzle is designed to be inserted underneath the belt of a treadmill with the tube having a length sufficient to reach the treadmill components that require lubrication. The extended tube is preferably constructed from a material that provides enough rigidity to prevent significant bending and/or kinking of the tube, while still allowing for enough flexibility that the tube can be inserted underneath the belt of a treadmill without breaking or snapping in half.

### BACKGROUND OF THE INVENTION

Treadmills can be used to enable a person to walk or run in place despite outdoor weather, climate, and time of day. In general, treadmills have a stationary structure, a translating surface, and one or more mechanisms for creating the translational movement. In a typical embodiment, an endless belt rotates about two parallel rollers located on opposite ends of the stationary structure. The stationary structure is designed such that the rotating endless belt is taut around the outer surface of the parallel rollers, and coupled to follow their rotational direction. A support platform, located slightly below the rotating endless belt, provides a rigid surface to support the weight of a user.

While the above-described treadmill design is satisfactory to provide a walking or running surface, it suffers from considerable friction among the components. For example, as the user steps onto the rotating belt, the belt is pressed against the support platform, thereby causing frictional contact between the stationary and non-stationary parts. This frictional contact is generated each time the user takes a step and may severely diminish the performance and longevity of the various treadmill components.

It is therefore advantageous to minimize the frictional contact between the rotating belt and the support platform of a treadmill. This is typically achieved by applying a lubricating medium between the two surfaces, prior to assembly and at servicing intervals. Unfortunately, servicing of treadmills is costly because the existing practice requires that a skilled technician loosen or remove the endless belt to apply a uniform and adequate layer of lubricant. Moreover, servicing renders the treadmill unusable for the period of time required for the service to be performed.

It is known in the art to provide treadmills with built-in lubricating devices, with the following patents being incorporated by reference herein. U.S. Pat. No. 5,643,144 describes a treadmill having continuous solid lubrication system between the inner surface of the endless belt and the support deck. The continuous solid lubrication system is positioned below the deck in a downwardly orientated position. The solid lubrication system includes a solid wax in an elongated solid lubricant channel. The channel is attached at an angle to the under side of the deck so that the channel and the solid wax engage the inner surface of the lower reach of the belt. The belt abrades the solid wax and the channel as it moves along its continuous path imparting lubrication to the belt. As increased tension is applied to the upper reach, more lubricant is applied to the inner surface of the belt.

U.S. Pat. No. 5,913,384 describes an elongated lubrication applicator that is used to manually lubricate the belt and/or belt supporting surface of an exercise treadmill. The lubrication applicator is optionally included in a kit containing lubricant and at least one treadmill belt tension adjusting device.

U.S. Pat. No. 7,335,135 describes a treadmill belt lubricating device for an electric treadmill comprising a transversal axle rod disposed at a frame of the treadmill, and a swinging lever longitudinally coupled to the axle rod, wherein an end of the lever includes an inertia weight, and the other end of the lever is coupled to a transversal U-shape retaining groove, and the retaining groove includes a wool felt, and a lubricant is filled into the wool felt. After the foregoing components are assembled, a roller is positioned precisely under the running board, and another end of the wool felt maintains a gap with the treadmill belt, and if the running board is vibrated, then the inertia swing of the lever weight drives the wool felt to be in contact with the bottom surface of the treadmill belt so as to achieve the effect of constantly lubricating the treadmill belt.

The majority of the lubrication systems of the prior art are designed to be installed ran the treadmill itself. The additional lubrication mechanisms and their control circuitry can significantly increase the cost of the treadmill, and their benefit can generally only be enjoyed by purchasers of new treadmills. Individual consumers who have already purchased a treadmill are unlikely to spend more for the latest improvement in treadmill technology.

Consequently, it would be advantageous to provide a device and method for lubricating the friction bearing surfaces of a treadmill that will enable quick and adequate lubrication while also reducing the overall time required for servicing. Additionally, it would be advantageous to provide a “do-it-yourself” treadmill lubrication system which may be used on any existing treadmill, obviating or reducing the need for a skilled service technician or the purchase of a new treadmill. Other and further objects and advantages of the present invention will appear hereinafter.

### BRIEF SUMMARY OF THE INVENTION

A treadmill lubrication system and method is provided. The system of the present invention provides a portable device for lubricating both new and pre-existing treadmills, negating the need to install a complicated and expensive lubrication system on the treadmill itself. The design of present invention also provides a system and method whereby a treadmill user or owner can deliver lubrication to the treadmill components without the need to contact a treadmill service professional. It is contemplated that the present invention may be stored or stationed in homes, gyms, or wherever a treadmill is used.

In a preferred embodiment, the lubrication system comprises a container or bottle with a spray nozzle including an extended tube through which a preferably silicone-based treadmill lubricant ay be sprayed. The extended tube of the nozzle is designed to be inserted underneath the belt of a treadmill with the tube having a length sufficient reach the treadmill components that require lubrication. The extended tube is preferably constructed from a material that provides enough rigidity to prevent significant bending and/or kinking of the tube, while still allowing for enough flexibility that the tube can be inserted underneath the belt of a treadmill without breaking or snapping in half.

The lubrication system of the present invention may include a variation of spray nozzles, with at least three different nozzle embodiments described herein. Preferably, each embodiment includes a spray bottle with spray nozzle and extended tube attachment. A first spray nozzle embodiment described herein comprises a threaded sprayer nozzle attachment with the extended tube affixed to a threaded cap that corresponds to the threaded spray nozzle. A second nozzle embodiment described herein comprises a high output pump-and-spray type spray head whereby the extended tube may slide on and off the spray head for easy removal and storage. A third nozzle embodiment described herein comprises a threaded spray nozzle attachment whereby both ends of a threaded cap are open such that one end may be threaded onto the spray bottle and the other end may receive the extended tube. The extended tube of this embodiment preferably includes a flared end that sites flush inside the threaded cap, thus forming a tight seal between the spray nozzle and spray bottle when the nozzle is attached.

### DESCRIPTION OF THE DRAWINGS

These and other features, aspects, and advantages of the present invention will become better understood with regard to the following description, appended claims, and accompanying drawings where:

FIG. 1a is a side view of a treadmill lubrication system in accordance with one aspect of the present invention, illustrating a threaded spray nozzle with extended tube;

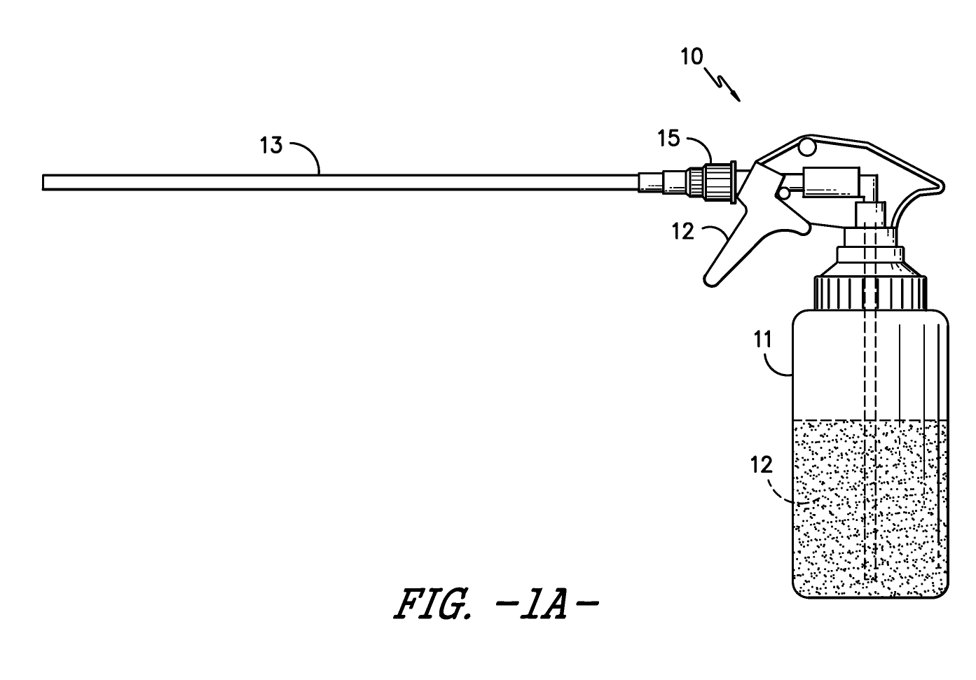

FIG. 1b is an exploded view of a treadmill lubrication system in accordance with one aspect of the present invention, illustrating a threaded spray nozzle with extended tube;

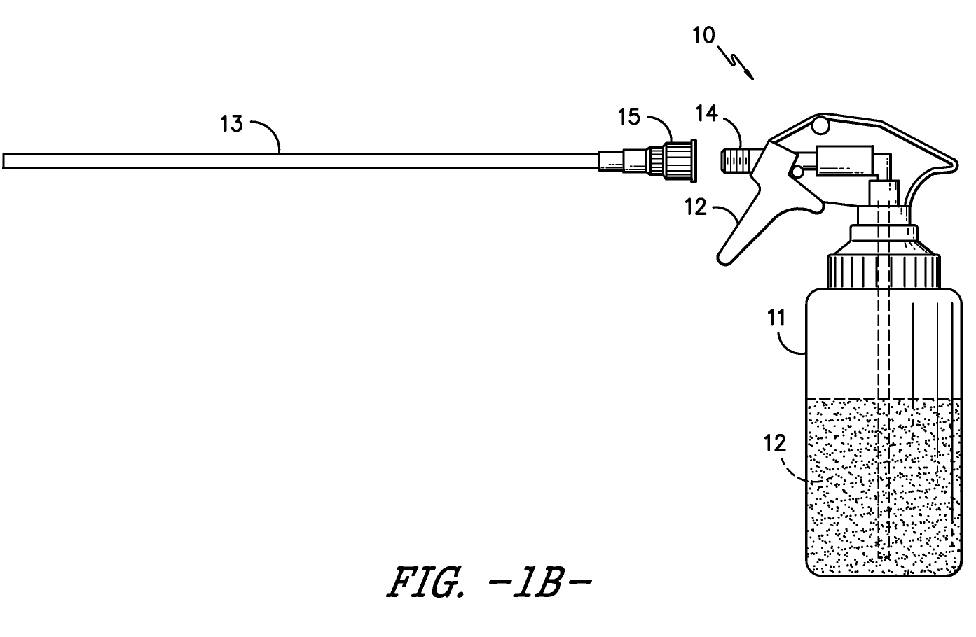

FIG. 2a is a side view of a treadmill lubrication system in accordance with one aspect of the present invention, illustrating a high output spray nozzle with removable extended tube;

FIG. 2b is an exploded view of a treadmill lubrication system in accordance with one aspect of the present invention, illustrating a high output spray nozzle with removable extended tube;

FIG. 3a is a side view of a treadmill lubrication system in accordance with one aspect of the present invention, illustrating a threaded spray nozzle with removable extended tube having a flared end;

FIG. 3b is a perspective view of a treadmill lubrication system in accordance with one aspect of the present invention, illustrating a removable extended tube having a flared end;

FIG. 3c is an exploded view of a treadmill lubrication system in accordance with one aspect of the present invention, illustrating a threaded spray nozzle with removable extended tube having a flared end;

FIG. 4 is an in-use view of a treadmill lubrication system in accordance with one aspect of the present invention, illustrating the extended tube of the lubrication system being inserted underneath the belt of a treadmill.

### DETAILED DESCRIPTION OF THE INVENTION

In one embodiment, the basic components of the present invention preferably comprise a container 11 or bottle for containing a treadmill lubrication medium 22, a spray nozzle with trigger mechanism 12 for releasing the lubricant spray, and a tube 13 with extended length, whereby the proximal end of the tube 13 is attached to the spray nozzle 12 and the distal end of the tube is inserted underneath the belt 21 of a treadmill 20 to reach the treadmill components that require lubrication.

FIGS. a and 1b illustrate one preferred embodiment of the treadmill lubrication system 10 of the present invention comprising a container 11, such as a spray bottle, with attachable extended trigger-type spray nozzle 12 with extended tube 13. In this embodiment, the spray bottle 11 includes a threaded nozzle portion 14 for receiving a corresponding threaded cap 15 of the extended spray tube 13. The extended tube 13 is affixed to the inner surface of the threaded cap 15 such that the threaded cap 15 and extended tube 13 may form a single piece at may be removably attached or threaded onto the corresponding threaded nozzle 14 of the spray bottle 11.

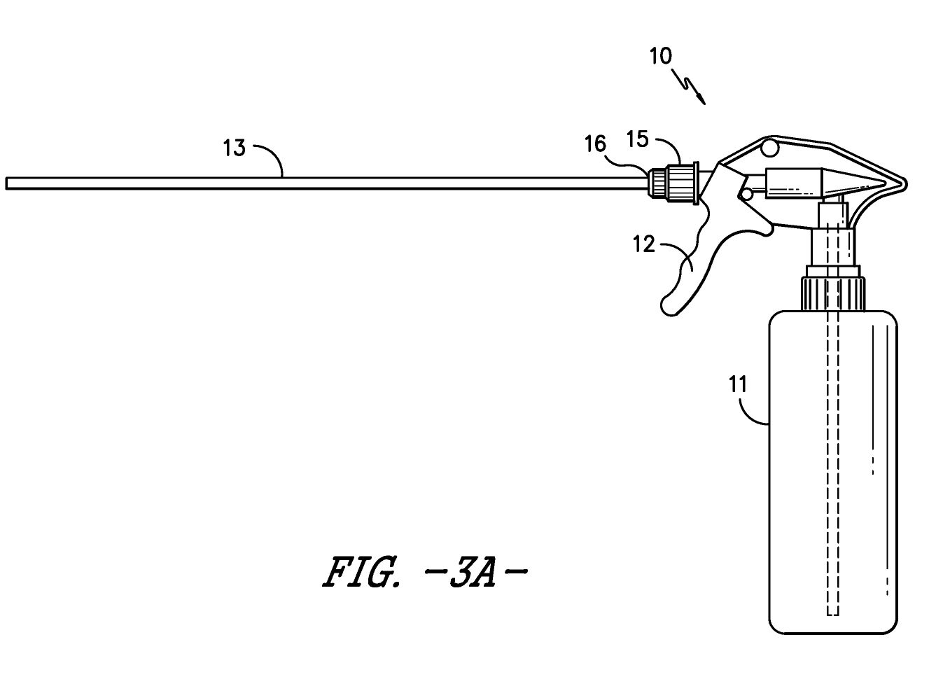

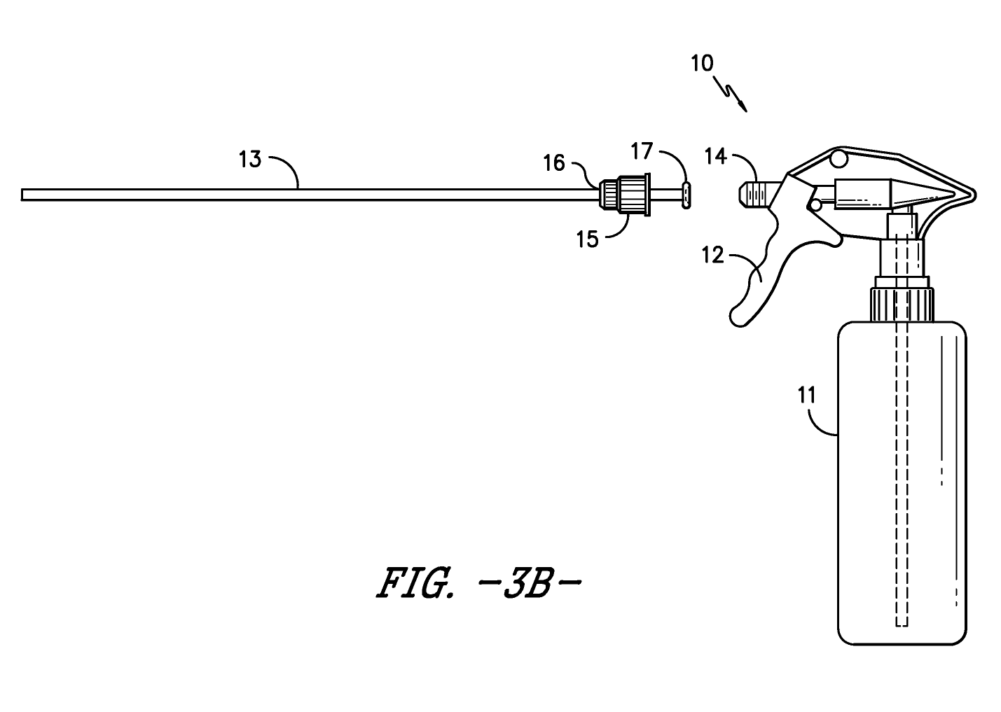

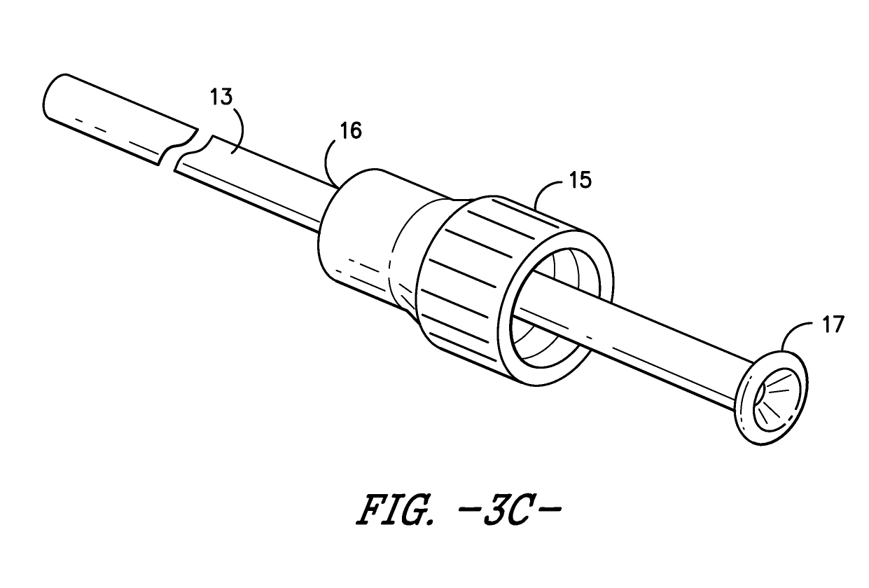

Alternatively, shown in FIGS. 3a-3c, the threaded cap 15 may be open on both ends, with one end being threaded for attaching to the threaded trigger-type nozzle 12 of the spray bottle 11, and the opposing end defining a hole 16 for receiving the extended tube 13. In this way the extended tube 13 may not be affixed to the inner surface of the threaded cap 15; rather, the extended tube 13 may be inserted through the hole 16 on the opposing end of the threaded cap 15, and the cap 15 with inserted tube 13 may be threaded onto the threaded nozzle portion 14 of the spray bottle 11. Additionally, in this embodiment, the extended tube 13 is preferably flared on one end 17, such that as the tube 13 is inserted through the hole 16 of the threaded cap 15, the flared end 17 sits flush with the inside surface of the cap 15 and is proximal to the spray bottle 11 when attached. It is contemplated that this flared end 17 will help create a tight seal at the tip of the spray nozzle 12.

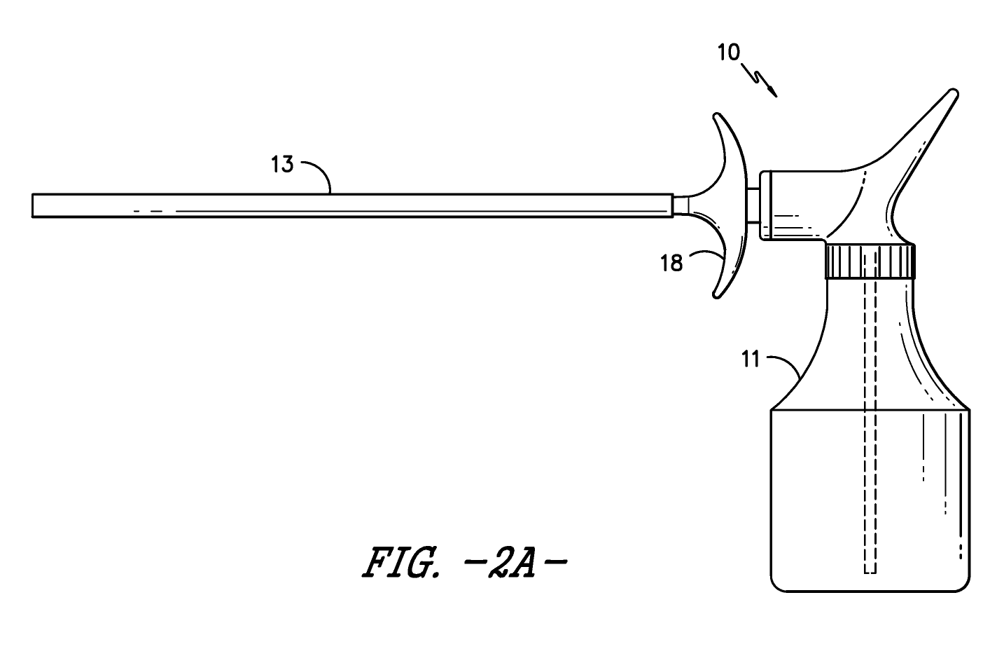

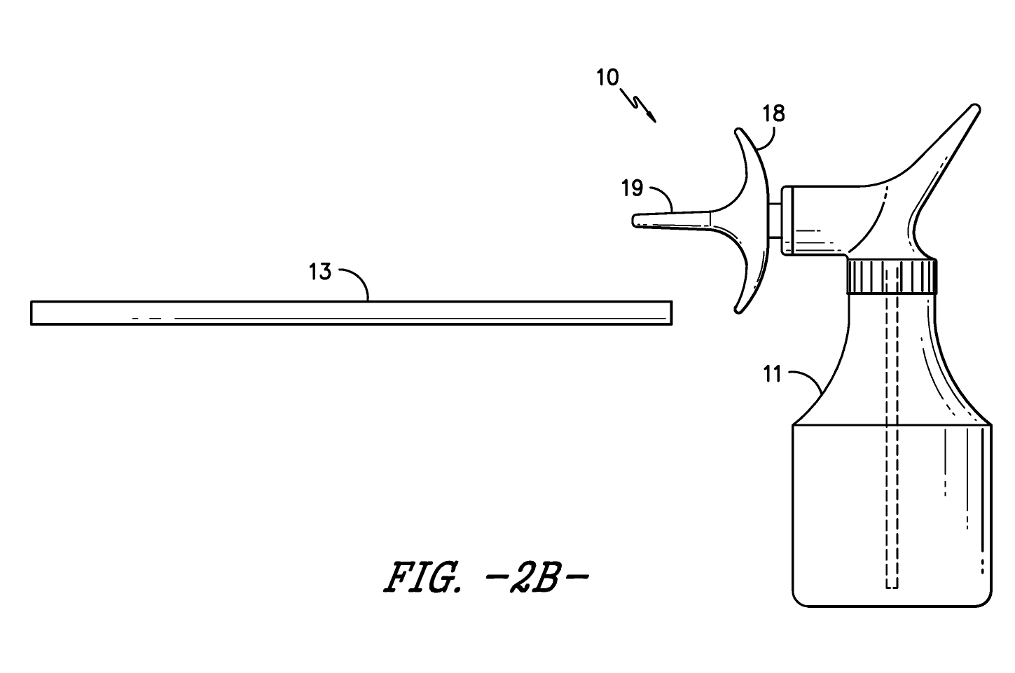

In a third embodiment, illustrated by FIGS. 2a-2b, a spray bottle may 11 include a pump and spray type of spray nozzle 18. Preferably, the nozzle tip 19 of the pump and spray nozzle 18 extends slightly and is smooth so that the extended tube 13 may slide on and off the nozzle 18 for easy storage. However, it is understood that the nozzle tip 19 may also be threaded to receive an extended tube 13 with threaded cap. An advantage to this type of nozzle is that the pump and spray type of nozzle is typically high-output and may be used to spray lubricant with the spray bottle in any orientation, such as upside down, sideways, upright, or any other position necessary to reach the components of the treadmill 20.

The extended tube attachment 13 that forms the extended spray nozzle of the treadmill lubrication system 10 is preferably constructed from a material that provides enough rigidity to prevent significant bending and/or kinking of the tube 13, while still allowing for enough flexibility that the tube 13 can be inserted underneath the belt 21 of a treadmill 20 without breaking or snapping in half. Some examples of preferred materials include acrylic glass (such as plexiglass) and polytetrafluoroethylene (such as Teflon), although similar suitable materials may be used. These types of materials have an inherent surface slipperiness that allows the tube 13 to slide easily between the rotating belt 21 and the support platform; while at the same time, these materials have a strength sufficient to resist kinking and breakage. A preferred material may have a frictional coefficient less than or equal to 1μ, more preferably less than or equal to 0.8μ.

The extended tube 13 may be any desired length for reaching the treadmill components requiring lubrication, although a preferred range of length may be approximately 4 to 12 inches. Additionally, the extended tube 13 has an inner diameter and an outer diameter, the dimensions of which may vary as desired. For example, a preferred range in outer diameter may be ⅛ to ¼ inch; a preferred inner diameter may be any diameter sufficient to allow the lubricant to be sprayed though the tube with sufficient pressure and in sufficient volume without excessive resistance. A greater difference in outer diameter versus inner diameter will result in more rigidity of the tube.

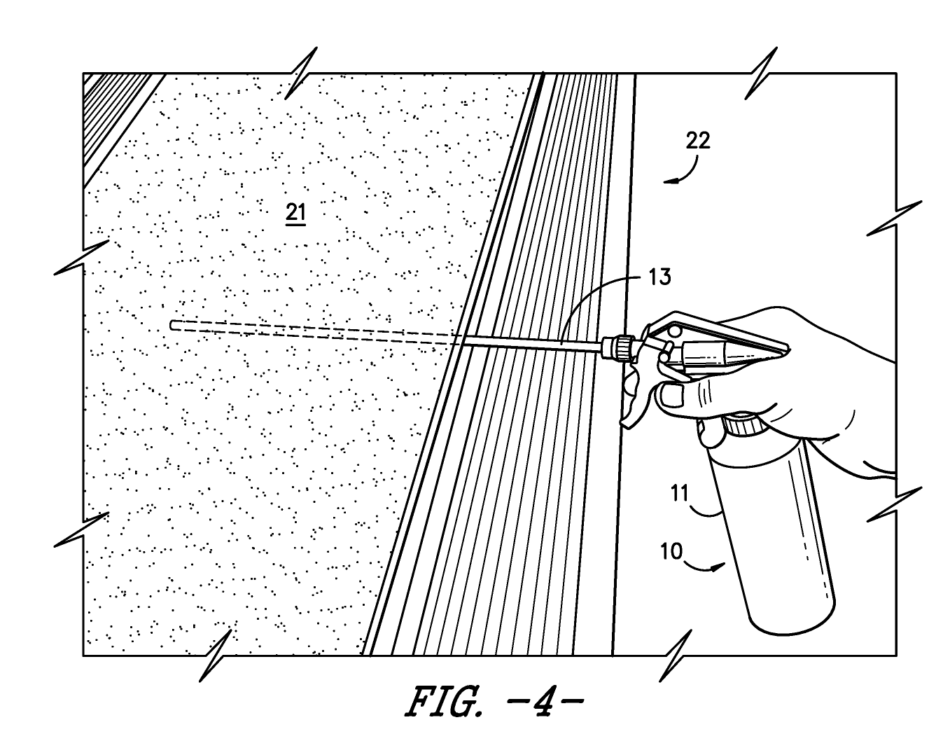

It is contemplated that the treadmill lubrication system 10 may be constructed, for example, according to one of the embodiments described herein, and the spray bottle 11 of the present invention may be filled with a food-grade silicone spray. As shown in FIG. 4, the extended tube 13 of the spray nozzle 12, 18 may be inserted or slid between the belt 21 and support platform of the treadmill 20, or wherever lubrication may be needed. The trigger 12 of the spray bottle 11 may be depressed, releasing the lubricant 22 onto the treadmill components. Once sufficient lubrication has been achieved, the extended tube 13 may be pulled out or removed from the treadmill 20. One advantage to a silicone-based lubricant used in conjunction with this system is that the lubricant may not clog or gunk up the extended tube or spray nozzle of this system. If cleaning of the apparatus 10 is needed, the extended tube 12, cap 15, spray nozzle 12, 18 and bottle 11 may be disassembled, cleaned, and reassembled for subsequent uses. Additionally, the system 10 may be partially or fully disassembled for storage and portability.

Although the present invention has been described in considerable detail with reference to certain preferred versions thereof, other versions are possible. Therefore, the spirit and scope of the appended claims should not be limited to the description of the preferred versions contained herein. All features disclosed in this specification may be, replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A treadmill lubrication system comprising:
a container having a spray nozzle adapted for receiving a tube, said spray nozzle further included a trigger mechanism, whereby said trigger mechanism may be activated to release a spray from said container;
a tube removably attached to said spray nozzle of said container, said tube extending outwardly from said container, whereby the distal end of said tube may be inserted underneath the belt of a treadmill; and
a treadmill lubrication medium placed inside said container, whereby said treadmill lubrication medium may be sprayed from said container and through said tube.

2. The treadmill lubrication system of claim 1, wherein said spray nozzle includes a threaded portion, and wherein said tube further includes a threaded cap; and
whereby said threaded cap may be threaded onto said threaded portion of said spray nozzle, thereby attaching said tube thereon.

3. The treadmill lubrication system of claim 2, wherein the proximal end of said tube is flared and sits flush with the inside of said threaded cap.

4. The treadmill lubrication system of claim 1, herein said trigger mechanism is a pump and spray trigger.

5. The treadmill lubrication system of claim 1, wherein said trigger mechanism may be activated and release a spray while said container is the position selected from the group consisting of upside down, sideways, and upright.

6. The treadmill lubrication system of claim 1, wherein the length of said tube is in the range of 4 inches to 12 inches.

7. The treadmill lubrication system of claim 1, wherein said tube is constructed from the group consisting of acrylic glass and polytetrafluoroethylene.

8. The treadmill lubrication system of claim 1, wherein said tube is constructed from a material having a frictional coefficient of less than or equal to 0.5μ.

9. A. treadmill lubrication system comprising:
a treadmill;
a container having a spray nozzle adapted for receiving a tube, said spray nozzle further included a trigger mechanism, whereby said trigger mechanism may be activated to release a spray from said container;
a tube adapted for attachment to said spray nozzle of said container, said tube extending outwardly from said container, whereby the distal end of said tube may be inserted underneath the belt of said treadmill; and
a treadmill lubrication medium placed inside said container, whereby said treadmill lubrication medium may be sprayed from said container and through said tube.

10. A method of lubricating the components of a treadmill comprising the steps of:
providing a treadmill;
providing a treadmill lubrication medium;
providing a container for containing said treadmill lubrication medium, said container including a spray nozzle with a tube extending from said spray nozzle;
inserting said tube underneath the belt of said treadmill;
activating said spray nozzle to release said treadmill lubrication medium; and
spraying the components of said treadmill with said lubrication medium.

11. The method set forth in claim 10, further including the steps of:
removing said tube from underneath the belt of said treadmill; and
disassembling said container, said spray nozzle, and said tube for storage.
